(19) United States
(12) Patent Application Publication
(10) Pub. No.: US 2025/0361951 A1
(43) Pub. Date: Nov. 27, 2025

(54) Detecting Passing Valves

(71) Applicant: Saudi Arabian Oil Company, Dhahran (SA)

(72) Inventors: Abdulwahab A. Halawani, Thuwal (SA); Ali Alrasheed, Thuwal (SA); Amjad Felemban, Thuwal (SA); Sahejad Patel, Thuwal (SA); Ahmed Al Brahim, Thuwal (SA)

(21) Appl. No.: 18/671,583

(22) Filed: May 22, 2024

(51) Int. Cl. F16K 37/00; G01M 3/00

(52) U.S. Cl. CPC F16K 37/0083; G01M 3/00

(57) ABSTRACT

Systems and methods include a sensor device for detecting passing valves. The sensor device includes a housing including a first side configured to contact a wall of a pipe in a pipe system. A cover plate is coupled to a second side of the housing opposite the first side. A piezoelectric sensor is disposed in the housing and configured to detect acoustic emissions from a valve in the pipe system. A sensor holder is disposed within the housing to maintain a position of the piezoelectric sensor. A spring is positioned around a portion of the sensor holder and configured to bias the sensor holder away from the cover plate and toward the first side of the housing. A computer system is mounted to the housing and configured to determine that a valve is a passing valve based on acoustic emissions detected by the piezoelectric sensor.

### TECHNICAL FIELD

The present disclosure relates to methods and systems for detecting passing valves.

### BACKGROUND

Oil and gas plants include a multitude of pipes and valves to transport fluids throughout the plant. Normal operation of valves is an open position or a closed position. A passing valve, however, allows a portion of the fluid to pass the valve when the valve is in a closed position. Passing valves can be caused by human error in not closing a valve completely and/or due to degradation or damage to the valve. Leakages caused by passing valves can be costly for the environment, operator health, and business profitability.

For example, unintentional passing of gases to a flare system in oil and gas plants is a common issue that can result in significant business losses and environmental hazards. Gases that are produced during the oil and gas production processes are often burned off in the flare system to reduce the amount of gas that is released into the atmosphere. However, when the gases are not meant to be burned, passing valves can result in a significant loss of valuable resources. In addition to business losses, unintentionally passing gases in the flaring system can also pose environmental hazards. The gases that escape into the atmosphere can contribute to air pollution, negatively impacting human health, wildlife, and the environment.

### SUMMARY

This disclosure describes systems and methods for detecting passing valves. A sensor device can be attached to a pipe in a pipe system to detect acoustic emissions. The sensor device can include a housing including a first side configured to contact a wall of a pipe in the pipe system and a second side opposite the first side. A cover plate can be coupled to the second side of the housing. A piezoelectric sensor can be positioned in the housing and configured to detect acoustic emissions from a valve in the pipe system. A sensor holder can be positioned within the housing to maintain a position of the piezoelectric sensor. A spring can be positioned around a portion of the sensor holder to bias the sensor holder away from the cover plate and toward the first side of the housing. A computer system can be mounted to the housing to determine that a valve is a passing valve based on acoustic emissions detected by the piezoelectric sensor.

Implementations of the systems and methods of this disclosure can provide various technical benefits. The sensor device can provide on-the-edge detection of passing valves without transmitting or uploading the data to a cloud or network server. On the edge detection of passing valves increases data handling security in comparison with processing data on a remote device because the data is not transmitted to a separate device over a network. Additionally, the sensor device can detect passing valves based on frequencies greater than the human audible range. Further, the sensor device is external to the pipe, independent of pressure sensors or flow sensors, and does not intrude into the pipe. The sensor device can detect passing valves automatically to enable early mitigation of the passing valves. The sensor device can be coupled to many sizes of pipes providing adaptability for different environments. The sensor device can include a high range, low energy transmission module to send data wirelessly over long distances where conventional wireless networks are not available. The sensor device can include a syringe mechanism that enables easy placement of couplant for the piezoelectric sensor which improves the performance of the piezoelectric sensor compared to not using couplant. The sensor device can harvest energy from the high vibration environment in which the sensor device is installed to charge the battery and extend the life of the device.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 is an exploded view of an example sensor device for detecting passing valves.

FIG. 2 is a perspective view of the example sensor device of FIG. 1.

FIG. 3 is a schematic of an example system for detecting passing valves.

FIG. 4 illustrates an example pipe system including sensor devices to detect passing valves.

FIG. 5 is a perspective view of another example passing valve.

FIG. 6 is a flowchart of an example method for detecting passing valves, according to some implementations of the present disclosure.

FIGS. 7A, 7B, 7C illustrate various valve types for which passing valves can be detected, according to some implementations of the present disclosure.

FIG. 8 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

Passing valves (e.g., closed valves that do not completely block the passage of fluids) can occur, for example, in the energy industry such as in oil and gas plants where an abundance of pipes and valves are used. Passing valves can be caused by human error (e.g., not fully closing the valve) and/or by a fault within the valve (e.g., degradation of valve components or damage to the valve). Leakages caused by passing valves can be costly for the environment, operator health, and business finances. For example, oil or gas leaks can contaminate the environment by releasing greenhouse gases, cause injury or disease to employees, and waste sellable assets.

This disclosure describes systems and methods for detecting passing valves. A sensor device can be attached to a pipe or valve in a pipe system. When installed on the pipe or valve, the sensor device holds the piezoelectric sensor against the pipe or valve wall. The sensor device can measure acoustic emissions such as sound or vibrations from the pipe using a piezoelectric sensor. The sensor device includes an onboard computer system to detect passing valves based on the acoustic emissions.

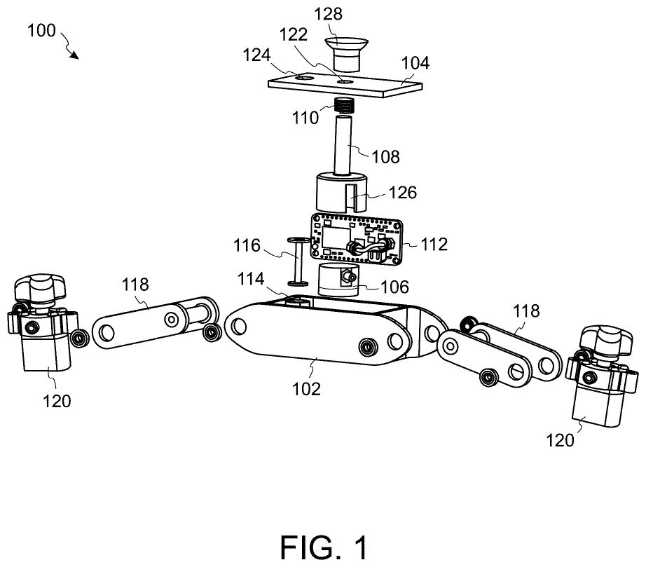

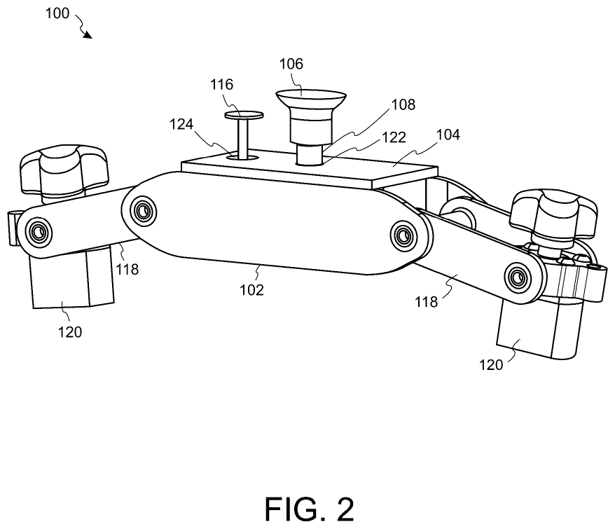

FIGS. 1 and 2 illustrate an example sensor device 100 for detecting passing valves in a pipe system. The sensor device 100 can be attached to a pipe near a valve to measure acoustic emissions from the valve. The sensor device 100 can be fitted to a variety of pipe sizes and materials.

The sensor device 100 includes a housing 102. The housing 102 provides protection for a piezoelectric sensor 106 and an onboard computer system 112. The housing 102 can also provide acoustic dampening, reducing noise detected by the piezoelectric sensor 106 from disturbances or ambient noises in the operating environment. A cover plate 104 is coupled to a first side 130 of the housing 102. For example, the cover plate 104 can be coupled to the housing 102 by bolts, screws, rivets, etc. The housing 102 and the cover plate 104 can be made from a variety of materials including metals and plastics. The choice of material can depend on the intended operating environment. For example, a material can be chosen that can resist corrosion in the operating environment and/or for compatibility with the pipe material. In some implementations, the housing 102 can be made from a flexible material that enables the housing 102 to conform to the curvature of a pipe surface. For example, the housing 102 can be made from thermoplastic elastomers (TPE), silicone rubber, or thermoplastic polyurethane (TPU).

The piezoelectric sensor 106 is positioned within the housing 102. The piezoelectric sensor 106 is configured to detect acoustic emissions (e.g., sound data and/or vibrational data) from a pipe to which the sensor device 100 is in contact. The piezoelectric sensor 106 is held in place by a sensor holder 108. The sensor holder 108 includes a recess 126 that is sized to receive the piezoelectric sensor 106. The recess 126 can be sized to have a snug fit with the piezoelectric sensor 106 such that the piezoelectric sensor 106 is held in place within the recess 126. The end of the sensor holder 108 with the recess 126 can have a larger diameter than a middle portion of the sensor holder 108. A handle 128 is attached to the sensor holder 108 on the end of the sensor holder 108 opposite the recess 126. The sensor holder 108 protrudes through an opening 122 in the cover plate 104 enabling adjustment of the piezoelectric sensor 106 when the cover plate 104 is attached to the housing 102.

A spring 110 is positioned around a portion of the sensor holder 108 (e.g., the middle portion) between the recess 126 and the cover plate 104. The spring 110 is configured to bias the sensor holder away from the cover plate 104 and toward the second side 132 of the housing 102 opposite the first side 130. The sensor holder 108 and the spring 110 enable the piezoelectric sensor 106 to be held in place while performing measurements. The sensor holder 108 and spring 110 also enables adjustment of the height of the piezoelectric sensor 106 relative to the pipe, for example, to inject a couplant fluid between the piezoelectric sensor 106 and the pipe.

The housing 102 also includes a syringe 114. The syringe 114 is configured to hold a couplant fluid to be injected between the piezoelectric sensor 108 and the pipe. A plunger rod 116 ejects the couplant fluid in the syringe 114 when the plunger rod 116 is depressed. The plunger rod 116 protrudes through an opening 124 in the cover plate 104 enabling the plunger rod 116 to be depressed when the housing 102 and the cover plate 104 are assembled. The couplant fluid can be a fluid that facilitates transmission of acoustic waves from the pipe to the piezoelectric sensor 106 to improve the accuracy of measurements of the acoustic emission data by the piezoelectric sensor 106. Examples of couplant fluids include water, oil, grease, gels, etc.

The sensor device 100 includes hinged arms 118 that connect magnets 120 to the housing 102. The hinged arms 118 are rotatably coupled to the housing 102 at one end and the magnets 120 at the opposite end. As shown in FIGS. 1 and 2, the hinged arms 118 use pin joints to connect to the housing 102 and the magnets 120. The hinged arms 118 enable the sensor device 100 to be coupled to a variety of different pipe diameters. The housing 102 can be held in contact with a pipe wall by adjusting the hinged arms 118 and the magnets 120. In some implementations, the hinged arms 118 include slots that enable the effective length of the hinged arms 118 to be adjusted. For example, the hinged arm can have a slot along the length of the hinged arm that allows the distance between the magnets 120 and the housing 102 to be adjusted by sliding the magnets 120 or the housing 102 closer to the other in the slot.

In some implementations, the magnets 120 are switchable magnets. The strength of the magnetic field of a switchable magnet is adjusted by rotating the magnet. In an “on” position, the switchable magnet has a strong magnetic field to magnetically attach to a magnetic surface. In an “off” position, the switchable magnet has a weak magnetic field and can be easily removed or repositioned on the magnetic surface.

The onboard computer system 112 can be, for example, a printed circuit board (PCB) with one or more processors, a computer-readable storage medium storing instructions, and circuitry for processing and conditioning signals from the piezoelectric sensor 106. The onboard computer system 112 is configured to detect the state of the valve in real-time using a trained machine learning model. The onboard computer system 112 can include electronic circuits for processing, conditioning, networking and inferring valve conditions. Various valve conditions can be monitored such as passing, not passing or quantification of product flowing through by utilizing machine learning models.

The onboard computer system 112 includes wireless communication hardware to facilitate transmission of acoustic emission data, the state of the valve, and/or predictions of valve performance. For example, the onboard computer system 112 can include a transceiver to transmit and receive wireless communication signals over wireless networks (e.g., Wi-Fi, wireless local area networks (WLAN)), cellular networks, and/or using short range radio communications. In some implementations, the onboard computer system 112 includes a high range, low energy transmission module to send data wirelessly over long distances where conventional wireless networks are not available.

In some implementations, the onboard computer system 112 includes additional sensors (e.g., accelerometers, temperature sensors, magnetometers etc.) that can be used to improve the accuracy of predictions for valve performance. For example, the data from the additional sensors can reduce the number of false positive or negative predictions improving reliability of the predictions by the sensor device 100. The machine learning model can be trained using data from the piezoelectric sensor and the additional sensor allowing for more complex insights and analysis. In some implementations, the onboard computers system can update model parameters of the trained machine learning model on signals received from the piezoelectric sensor and/or the additional sensors.

In some implementations, the sensor device 100 has multiple sensor channels to further improve passing detections or overall valve condition monitoring through multiple piezoelectric sensors at multiple locations along a pipe or valve. For example, the device can have piezoelectric sensors situated on the upstream side, the downstream side, and on the body of a valve. The piezoelectric sensors can be communicatively coupled to a single sensor device 100. The multiple channels can improve the prediction accuracy of the model as compared with a single channel.

The sensor device 100 can operate on battery power for standalone applications, employing energy-efficient components and power management strategies to extend battery life, e.g., sleep mode. Alternatively, if the inspected valve is not a manual valve, the sensor device 100 can be powered by the actuator power of the valve (or any other nearby source), removing complications resulting from powering the device. In some implementations, the sensor device 100 includes an energy harvesting module to harvest energy from vibrations of the pipe on which the sensor device is installed. For example, the energy harvesting module can include piezoelectric, electrostatic, or electromagnetic components to convert mechanical vibrations to electricity. These power sources options can make the device easy to be deployed across the facility for extended periods of time.

Real-time or near real-time processing and/or communication refers to a scenario in which received data (e.g., acoustic emission data) are processed as made available to systems and devices requesting those data immediately (e.g., within milliseconds, tens of milliseconds, or hundreds of milliseconds) after the processing of those data are completed, without introducing data persistence or store-then-forward actions. In this context, a real-time communication system is configured to process acoustic emission data as it arrives and determine if the valve is a passing valve as quickly as possible (though processing latency may occur). Though data can be buffered between module interfaces in a pipelined architecture, each individual module operates on the most recent data available to it. The overall result is a workflow that, in a real-time context, receives a data stream (e.g., acoustic emission data) and outputs processed data (e.g., valve classification) based on that data stream in a first-in, first out manner. However, non-real-time contexts are also possible, in which data are stored (either in memory or persistently) for processing at a later time. In this context, modules of the data processing system do not necessarily operate on the most recent data available.

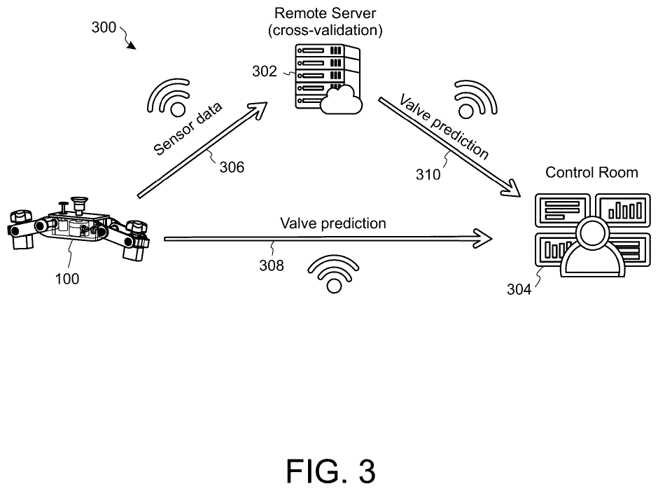

FIG. 3 is a block diagram of an example system 300 for detecting passing valves. The system 300 includes the sensor device 100 and additional computer systems 302 and 304 located separately from the sensor device 100. The sensor device 100 can communicate with the additional computer systems 302 and 304 over wireless networks (e.g., Wi-Fi, cellular, short range radio communications). Additional computer systems 302 and 304 can be communicatively coupled over wired networks (e.g., ethernet, LAN) or wireless networks.

In some implementations, the computer system 302 is a cloud computing system located in a data center, and the computer system 304 is located in a control room of a facility that includes a pipe system (e.g., refinery, gas plant, factory, etc.). The computer system 302 can receive sensor data 306 from the sensor device 100. The sensor data 306 can include piezoelectric sensor data (e.g., acoustic emissions data) and data from additional sensors on the sensor device 100. The computer system 302 can process the sensor data 306 using a machine learning model. The machine learning model can be substantially similar to a machine learning model on the sensor device 100. Alternatively, or additionally, the computer system 302 can use a different machine learning model. In some implementations, the machine learning model used on the computer system 302 is more complex (e.g., uses more inputs, includes more layers, requires more computations) than the machine learning model on the sensor device 100.

The computer system 304 receives valve predictions 308, 310 from the sensor device 100 and the computer system 302 based on the outputs of the respective machine learning models. The computer system 304 can validate the valve prediction 308 from the sensor device 100 based on the valve prediction 310 from the computer system 302. In some implementations, the computer system 304 can update the machine learning model on the sensor device 100 based on the valve predictions 308 and 310. In some implementations, computer systems 302 and 304 are the same computer system and/or are co-located computer systems.

The computer systems 302, 304 provide more computational power that can use more advanced deep learning architectures (e.g., cross-validation and redundancy) than used on the sensor device 100. The computer systems 302, 304 can also provide long-term data storage, historical analysis, and remote monitoring. This dual architecture can optimize performance, scalability, and adaptability of the sensor device 100 throughout an entire facility.

A user interface can be accessible via a mobile application or web dashboard. Users can monitor valve status in real-time, receive timely alerts for anomalies, and access historical data. The user interface will also provide predictive maintenance recommendations to assist operators in planning maintenance activities efficiently.

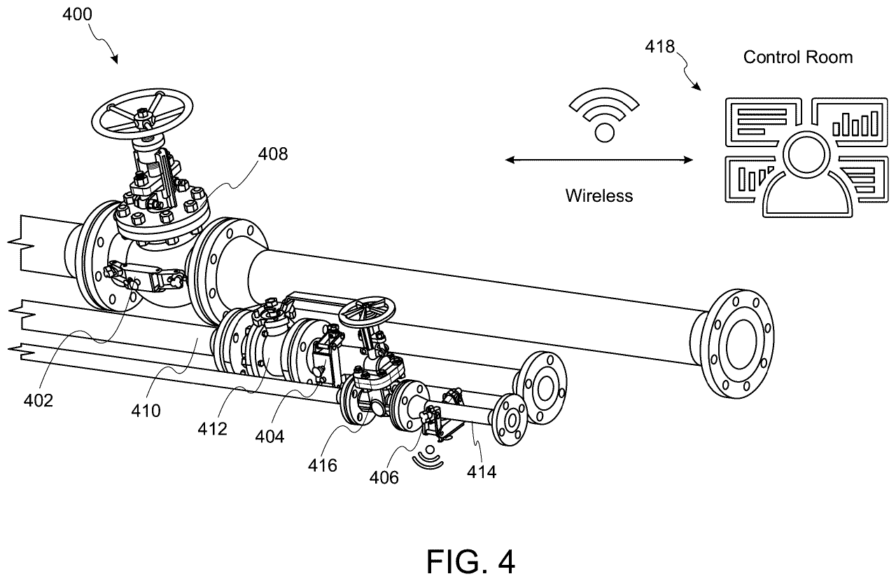

FIG. 4 is an illustration of a pipe system 400 with multiple sensor devices 402, 404, 406. Each sensor device 402, 404, 406 can be substantially similar to sensor device 100. The hinged arms of the sensor devices 402, 404, 406 enable the sensor devices 402, 404, 406 to be coupled to many sizes of pipes and/or valves in the pipe system 400. Sensor device 402 is magnetically coupled to the side of a large globe valve 408. Sensor device 404 is magnetically coupled around a medium sized pipe 410 near a valve 412. Sensor device 406 is magnetically coupled to a small diameter pipe 414 near a gate valve 416.

The sensor devices 402, 404, 406 can be deployed throughout a facility to enable real-time detection of valve leaks, preventing both environmental harm and financial losses associated with passing valves such as valves connected to a flaring system. The sensor devices 402, 404, 406 are also equipped with a network/wireless communications module enabling communication of the prediction of the valve's status directly to a control room in order to take the appropriate corrective actions (e.g., shutting valves upstream of the passing valve, shutting down the facility, etc.). The sensor devices 402, 404, 406 can be positioned downstream, upstream, or on the valve body.

Each of the sensor devices 402, 404, 406 can wirelessly communicate (e.g., over Wi-Fi, cellular networks, or short range radio communications networks) with one or more computer systems 418 located separately from the sensor devices 402, 404, 406. The one or more computer systems 418 can provide additional computational power to validate the predictions made by the sensor devices 402, 404, 406. The one or more computer systems 418 can also provide remote monitoring capabilities for the pipe system 400.

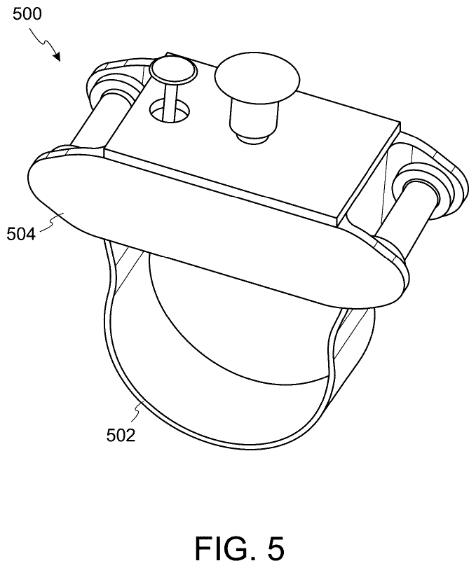

FIG. 5 is another example sensor device 500. The sensor device 500 is substantially similar to the sensor device 100 with the main difference being the attachment mechanism to couple the sensor device 500 to a pipe. The sensor device 500 includes a strap 502 that attaches to each end of the housing 504 of the sensor device 500. The strap 502 can be, for example, an elastic strap, a plastic strap, a cloth strap, or a cloth strap with hook and loop fasteners. The strap 502 enables the sensor device 500 to be coupled to non-magnetic pipes or valves (e.g., plastic, aluminum, concrete, etc.).

In some implementations, alternate attachment mechanisms can be used. For example, clamps, clamps with strings, permanent coupling clay can be used to couple the sensor devices to pipes. In some implementations, the sensor device can also include an alignment sensor to detect that the sensor device is in contact with a pipe when installed on the pipe. The alignment sensor can be, for example, a push button switch that is depressed when the sensor device is installed on the pipe and is extended when the sensor device is not in contact with the pipe.

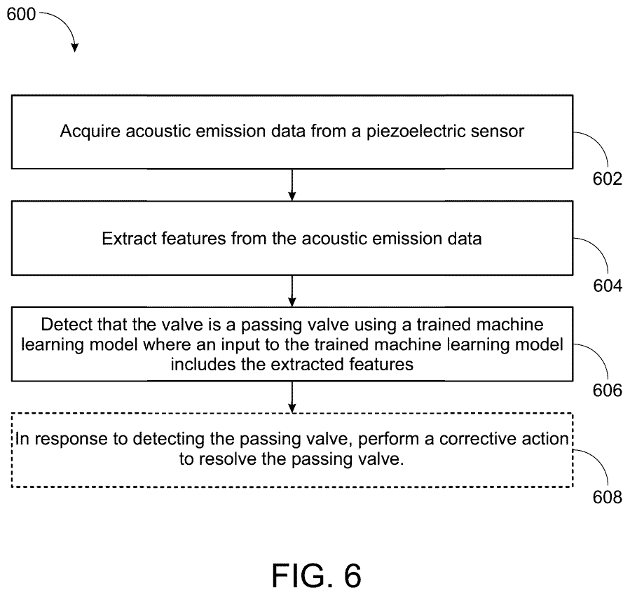

FIG. 6 is a flow chart for an example method 600 for detecting passing valves. The method 600 can be implemented on a data processing system such as a computer or control system (e.g., onboard computer system 112, computer systems 302, 304, 418). In some examples, the method 600 is implemented on one or more processors included in sensor device (sensor devices 100, 402, 404, 406, 500) attached to a pipe, thereby enabling the method to be executed on-the-edge (e.g., near the point of data collection). In other examples, the data processing system is separate from the sensor device.

At step 602, the data processing system acquires acoustic emission data from a piezoelectric sensor. The piezoelectric sensor can be with integrated electronics to measure the acoustic emissions and process the measured data without communicating with a computing system external to the sensor and its associated electronics. The piezoelectric sensor can be coupled to a pipe near a valve of interest. For example, the sensor can be attached to a pipe with magnets at a location on the downstream side of a valve. Magnetically attaching the sensor to the pipe can enhance the acoustic emission readings by reducing measurements of ambient noise. The sensor can be sensitive to vibrations from the valve. In implementations having non-magnetic pipes, the sensor can be coupled to the pipe through other means such as clamps, bolts, and/or zip-ties. The sensor can be communicatively coupled with other computing devices to transmit and receive data such as passing valve detection alerts and sensor status. In some implementations, the data processing system acquires the acoustic emission data from a data store storing data previously acquired from a piezoelectric sensor.

At step 604, the data processing system extracts features from the acoustic emission data. Extracting features from the acoustic emission data can include processing of the data to reduce noise and/or isolate frequencies outside a desired range. For example, the data processing system can apply a bandpass filter to the acoustic emission data. The bandpass filter attenuates frequencies outside of a specified band to isolate frequencies indicative of passing valves (e.g., 50-500 kilo Hertz (kHz), 100-300 kHz, 20-500 kHz). The lower frequency limit can be specified, for example, to attenuate anticipated low frequency noise such as noise from vibrations or sounds caused by operating machinery or sounds in the human audible range. The upper limit of the frequency range can be selected, for example, based on the sampling frequency of the sensor or a multiple of a known peak frequency.

In some implementations, the piezoelectric sensor is an analog sensor, and the bandpass filter is an analog bandpass filter applied before digitization of the signal from the sensor. In some implementations, the bandpass filter is applied by the data processing system after the signal has been converted from an analog signal to a digital signal.

The data processing system can convert an analog signal from the piezoelectric sensor to a digital signal using a high-sampling rate analog to digital converter (ADC). The sampling rate of the ADC can be sufficiently high to satisfy the Nyquist criterion based on an anticipated maximum frequency to be measured. For example, fluids leaking past a passing valve can generate frequency peaks around 150 kHz. In this example, a sampling rate of at least 300 kHz can be used to detect the 150 kHz frequency. Higher sampling rates (e.g., 500 kHz or more, 1 MHz or more, 2 MHz or more) can be used to further resolve the desired frequencies. In contrast, closed valves (e.g., not passing) generate uniform frequency spectra (e.g., without distinct peaks) in the frequency range of 20-500 kHz.

The data processing system can extract features from the acoustic emission data including time domain features, frequency domain features, or both. Time domain features include, for example, a root mean square (RMS) of the vibrational data that give a measure of the magnitude of the signal and zero-crossing rate which counts the number of times that the vibrational data changes from a positive value to a negative value or vice versa. Frequency domain features can include, for example, spectral roll-off, spectral bandwidth, frequency with maximum amplitude, frequency with maximum time averaged amplitude, and Mel-Frequency Cepstral Coefficients (MFCCs). Spectral roll off is a measure of the shape of the power spectrum of the vibrational data. In particular, it measures the frequency at which high frequencies decline to zero. Spectral Bandwidth is a weighted mean of the distances of frequency bands form the spectral centroid. Frequency value with maximum amplitude and frequency value with maximum time-average amplitude can be determined based on a spectrogram representing the vibrational data. MFCCs give short-term power spectrum of the signal, which can be useful to distinguish vibrational data having different frequency content (e.g., passing and closed valves). For example, 5-20 MFCC coefficients can be extracted.

In an example implementation, the data processing system extracts 27 features (20 MFCC coefficients, RMS, zero crossing rate, spectral centroid, roll off, and 3 bandwidths) from the raw vibrational data. More or fewer features can be extracted from the raw data. The number of features extracted can depend on the raw input data and the performance of a machine learning model trained on the features. In this example, the data processing system transforms the 200,000 inputs from the raw vibrational data into 27 input features which can increase the performance, the speed, and the efficiency of the machine learning model compared to passing the original sensor's data.

In some implementations, the data processing system transforms the raw input data or features extracted from the raw input data into a form more suitable for use by a machine learning model. For example, a principal components analysis (PCA) can be performed on extracted features to reduce the dimensionality (e.g., number of input variables) of the training data.

In some implementations, the data processing system generates a spectrogram based on the acoustic emission data. A spectrogram can represent time variation of the frequency content of a measured signal. For example, a spectrogram can be a two-dimensional image with the vertical axis representing frequency, the horizontal axis representing time and the image grayscale intensity or color values of the pixels in the image can represent the amplitude of the measured signal at the corresponding frequency and time. Including the time variation can decrease the effects of noise on the signal since external noise can be a shorter duration than the signal length. The external noise would therefore not affect each time step of the acoustic emission data and the spectrogram. Including the time variation of the signal can give the model more discriminatory power as compared with a power spectral density without time variation.

In some implementations, the data processing system generates spectrograms based on a 100 millisecond (ms) sample of vibrational data. The data processing system can generate the spectrograms by apply a sliding window of Fast Fourier Transforms (FFTs). The length of each window can be, for example, 256 samples and there can be an overlap, e.g., 50% overlap, between windows. The length of each window and the overlap between windows are parameters that can be tuned to generate spectrograms with desired frequency resolution and/or desired time resolution. For example, increasing the number of samples per window can increase the frequency resolution in the spectrogram while decreasing the temporal resolution. The temporal resolution can be increased or decreased by changing the window overlap, e.g., a larger overlap will increase the temporal resolution and a smaller overlap will decrease the temporal resolution.

At step 606, the data processing system detects that the valve is a passing valve using a trained machine learning model where an input to the trained machine learning model includes the extracted features. The machine learning model can be, for example, a random forest model, a k-nearest neighbors model, an artificial neural network (ANN), a support vector machine (SVM), an XGBoost model, or a convolutional neural network (CNN). Training data for the machine learning model can include acoustic emission data collected from a testing device having multiple valve types and pipe diameters. The trained machine learning model processes the features selected during feature extraction and outputs a binary classification (e.g., 0 for a closed valve and 1 for a passing valve).

In some implementations, the output of the machine learning model can be a probability of the valve being a passing valve (e.g., by using regression models). The probability output by the machine learning model can also be used to determine a health of the valve. For example, a low probability (e.g., less than 10%, less than 20%, less than 30%) can indicate a healthy valve. A moderately low probability (e.g., between 10% and 50%, between 10% and 50%, between 20% and 60%, between 30% and 70%) can indicate a deteriorating valve. Higher probabilities (e.g., greater than 50%, greater than 60%, greater than 70%) can indicate the valve is failing (e.g., passing fluids).

At step 608, in response to detecting the passing valve, the data processing system performs a corrective action to resolve the passing valve. In some implementations, the data processing system performs a corrective action including generating an alert indicating the detection of the passing valve. For example, the data processing system can generate an audible alert and/or a visual alert at the location of the passing valve. Alternatively, or additionally, the data processing system can transmit a signal to a computing device (e.g., a mobile device) that includes a display device to display an alert indicating that a passing valve was detected.

In some implementations, the data processing system performs a corrective action including automatically closing a valve upstream of the detected passing valve. For example, the data processing system can generate a control signal to electronically close a valve located upstream of the detected passing valve to prevent leaks through the passing valve.

Table 1 shows the classification accuracy for each of the trained models in comparison with a trained CNN. Both the SVM and ANN models were separately trained with a training set including 27 features, a training set including 8 features identified by PCA, a training set with 5 most important features, and a training set including the 3 most important features. An ANN trained with 3 most important features had the highest accuracy matching the accuracy of the CNN. Testing was done on the same computer. The ANN computed the predictions in 0.000082 seconds as compared with 0.108 seconds for the CNN resulting in more than a 1000× increase in speed. The low complexity of the ANN coupled with the low processing time can enable detection of passing valves by lower power on-board computing devices (e.g., a microcontroller).

TABLE 1
Machine Learning Model Test Results

| | Testing | Inference Time |
|---|---|---|
| Model | Accuracy | (i7 CPU) [s] |
| Spectrogram + CNN (baseline) | 100% | 0.108 |
| 27 features + SVM | 90% | 0.000092 |
| 27 features + ANN | 95% | 0.000085 |
| 8 features (PCA) + SVM | 90% | 0.000092 |
| 8 features (PCA) + ANN | 95% | 0.000084 |
| 5 most important features + | 98% | 0.000115 |
| SVM | | |
| 3 most important features + | 100% | 0.000082 |
| ANN | | |

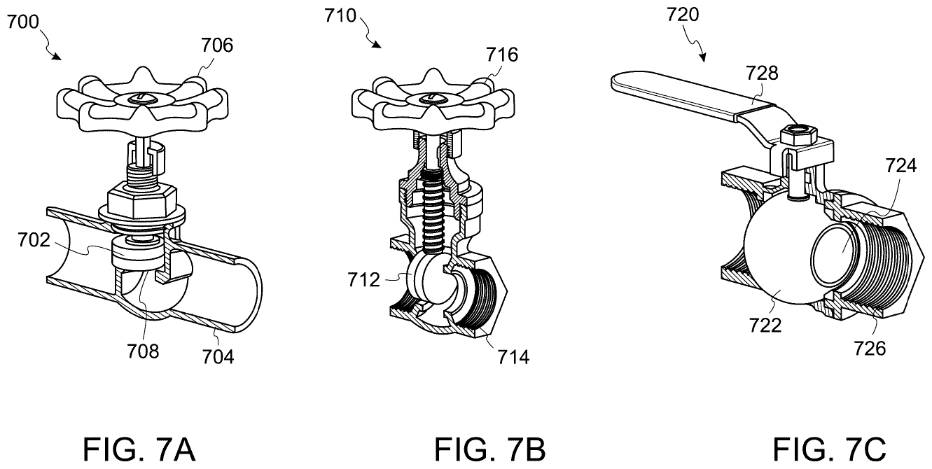

FIGS. 7A-7C show cut away illustrations of example valves 700, 710, and 720. The globe valve 700 includes a plug 702 that can be translated perpendicularly to a longitudinal axis of the pipe 704 by turning the handle 706. The plug 702 blocks an orifice 708 to prevent fluid flow through the pipe 704 when the globe valve 700 is in a fully closed position. The gate valve 710 includes a gate 712 that is perpendicular to the longitudinal axis of the pipe 714. The gate 712 is translated perpendicularly to the longitudinal axis of the pipe by rotating the handle 716. The gate 712 blocks the flow of fluid through the pipe 714 when in a fully closed position. The ball valve 720 includes a ball 722 with a hole 724 bored through the ball 722. The ball 722 can be rotated about an axis perpendicular to a longitudinal axis of the pipe 726. The ball valve 720 can be closed or opened by a quarter turn of the handle 728.

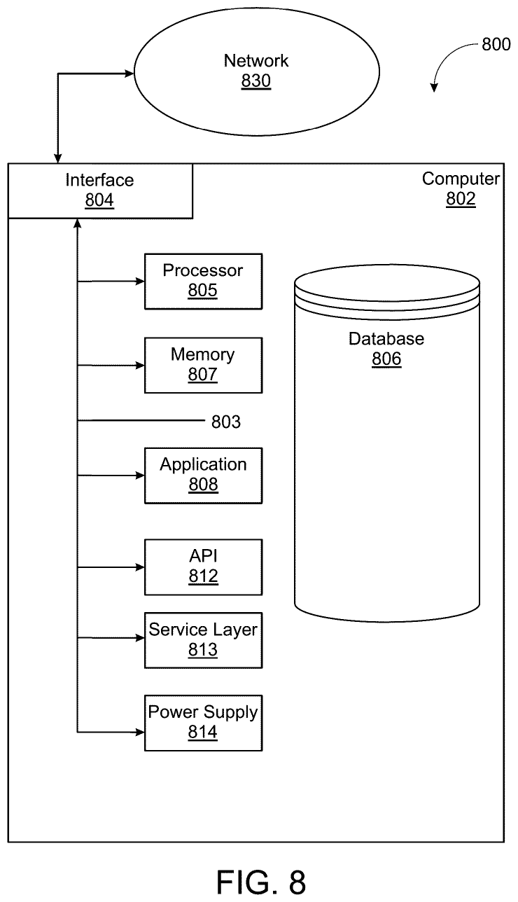

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 803. In some implementations, any or all of the components of the computer 802, including hardware or software components, can interface with each other or the interface 804 (or a combination of both), over the system bus 803. Interfaces can use an application programming interface (API) 812, a service layer 813, or a combination of the API 812 and service layer 813. The API 812 can include specifications for routines, data structures, and object classes. The API 812 can be either computer-language independent or dependent. The API 812 can refer to a complete interface, a single function, or a set of APIs.

The service layer 813 can provide software services to the computer 802 and other components (whether illustrated or not) that are communicably coupled to the computer 802. The functionality of the computer 802 can be accessible for all service consumers using this service layer. Software services, such as those provided by the service layer 813, can provide reusable, defined functionalities through a defined interface. For example, the interface can be software written in JAVA, C++, or a language providing data in extensible markup language (XML) format. While illustrated as an integrated component of the computer 802, in alternative implementations, the API 812 or the service layer 813 can be stand-alone components in relation to other components of the computer 802 and other components communicably coupled to the computer 802. Moreover, any or all parts of the API 812 or the service layer 813 can be implemented as child or sub-modules of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the interface's hardware can be operable to communicate physical signals within and outside of the illustrated computer 802.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and can manipulate data to perform the operations of the computer 802, including operations using algorithms, methods, functions, processes, flows, and procedures as described in the present disclosure.

The computer 802 also includes a database 806 that can hold data for the computer 802 and other components connected to the network 830 (whether illustrated or not). For example, database 806 can be an in-memory, conventional, or a database storing data consistent with the present disclosure. In some implementations, database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

The application 808 can be an algorithmic software engine providing functionality according to particular needs, desires, or particular implementations of the computer 802 and the described functionality. For example, application 808 can serve as one or more components, modules, or applications. Further, although illustrated as a single application 808, the application 808 can be implemented as multiple applications 808 on the computer 802. In addition, although illustrated as internal to the computer 802, in alternative implementations, the application 808 can be external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system containing computer 802, with each computer 802 communicating over network 830. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### EXAMPLES

In an example implementation, a device for detecting passing valves includes a housing including a first side configured to contact a wall of a pipe in a pipe system and a second side opposite the first side; a cover plate coupled to the second side of the housing; a piezoelectric sensor disposed in the housing and configured to detect acoustic emissions from a valve in the pipe system; a sensor holder disposed within the housing and configured to maintain a position of the piezoelectric sensor; a spring positioned around a portion of the sensor holder and configured to bias the sensor holder away from the cover plate and toward the first side of the housing; and a computer system including at least one processor and a computer-readable medium storing instructions executable by the at least one processor, the computer system mounted to the housing and configured to determine that a valve is a passing valve based on acoustic emissions detected by the piezoelectric sensor.

In an aspect combinable with the example implementation, the instructions include acquiring acoustic emission data from the piezoelectric sensor; and detecting that the valve is a passing valve using a trained machine learning model where an input to the trained machine learning model is based on the acoustic emission data.

Another aspect combinable with any of the previous aspects includes a strap attached to first and second ends of the housing, the strap configured to maintain contact between the first side of the housing and the pipe.

Another aspect combinable with any of the previous aspects includes first and second hinged segments rotatably coupled to respective first and second ends of the housing; and magnets coupled to the first and second hinged segments configured to magnetically couple the housing to the pipe.

In another aspect combinable with any of the previous aspects, the magnets include switchable magnets.

In another aspect combinable with any of the previous aspects, the sensor holder includes a recess at a first end and a handle at a second end opposite the first end.

In another aspect combinable with any of the previous aspects, the recess is sized to hold the piezoelectric sensor and a portion of the sensor holder protrudes through an opening of the cover plate.

Another aspect combinable with any of the previous aspects includes a syringe disposed in the housing, the syringe configured to hold a fluid to be injected between the piezoelectric sensor and the pipe.

Another aspect combinable with any of the previous aspects includes one or more additional sensors disposed within the housing.

In another aspect combinable with any of the previous aspects, the one or more additional sensors include one or more of an accelerometer, a piezoelectric sensor, a temperature sensor, and a magnetometer.

In another aspect combinable with any of the previous aspects, determining that the valve is a passing valve is based on the received signals from the piezoelectric sensor and signals from the one or more additional sensors.

In another example implementation, a system for detecting passing valves includes a sensor device including a housing including a first side configured to contact a wall of a pipe in a pipe system and a second side opposite the first side; a cover plate coupled to the second side of the housing; a piezoelectric sensor disposed in the housing and configured to detect acoustic emissions from a valve in the pipe system; a sensor holder disposed within the housing and configured to maintain a position of the piezoelectric sensor; a spring positioned around a portion of the sensor holder and configured to bias the sensor holder away from the cover plate and toward the first side of the housing; a first computer system mounted to the housing including at least one processor and a computer-readable medium storing instructions executable by the at least one processor, the computer system configured to transmit acoustic emission data to a computer system located separately from the sensor device; and a second computer system located separately from the sensor device, the second computer system including at least one processor and a computer-readable medium storing instructions executable by the at least one processor, the second computer system configured to determine that the valve is a passing valve based on the acoustic emission data.

In an aspect combinable with the example implementation, the second computer system includes instructions to receive the acoustic emission data from the first computer system; extract features from the acoustic emission data; and determine that the valve is a passing valve using a trained machine learning model that receives the extracted features as inputs.

In an aspect combinable with any of the previous aspects, the first computer system includes instructions to receive signals from the piezoelectric sensor; extract features from the received signals; determine that the valve is a passing valve based on a second trained machine learning model that receives the extracted features as inputs; and transmit output of the second trained machine learning model to the second computer system, where the second computer system further includes instructions to validate the output of the second trained machine learning model based on output of the first trained machine learning model.

Another aspect combinable with any of the previous aspects includes one or more additional sensors disposed within the housing, the one or more additional sensors including one or more of an accelerometer, a piezoelectric sensor, a temperature sensor, and a magnetometer, where determining that the valve is a passing valve is based on the received signals from the piezoelectric sensor and signals from the one or more additional sensors.

In another example implementation, a method for detecting passing valves includes acquiring, by a computer system, acoustic emission data from a piezoelectric sensor; extracting, by the computer system, features from the acoustic emission data; and detecting, by the computer system, that the valve is a passing valve using a trained machine learning model where an input to the trained machine learning model includes the extracted features.

An aspect combinable with the example implementation includes coupling a piezoelectric sensor device to a pipe near a valve, the piezoelectric sensor device including a piezoelectric sensor and the computer system.

Another aspect combinable with any of the previous aspects includes injecting a fluid between the piezoelectric sensor and the pipe using a syringe disposed within a housing of the piezoelectric sensor device.

In another aspect combinable with any of the previous aspects, the computer system is a first computer system, and the method includes transmitting the acoustic emission data to a second computer system; and determining, by the second computer system, that the valve is a passing valve using a second trained machine learning model, where the second computer system validates the determination of the first computer system.

In another aspect combinable with any of the previous aspects, extracting the features includes determining one or more of a root mean square value, a spectral roll off, a spectral bandwidth, a zero-crossing rate, Mel-Frequency Cepstral Coefficients, and a spectrogram.

What is claimed is:

1. A device for detecting passing valves, the device comprising:
a housing comprising a first side configured to contact a wall of a pipe in a pipe system and a second side opposite the first side;
a cover plate coupled to the second side of the housing;
a piezoelectric sensor disposed in the housing and configured to detect acoustic emissions from a valve in the pipe system;
a sensor holder disposed within the housing and configured to maintain a position of the piezoelectric sensor;
a spring positioned around a portion of the sensor holder and configured to bias the sensor holder away from the cover plate and toward the first side of the housing; and
a computer system comprising at least one processor and a computer-readable medium storing instructions executable by the at least one processor, the computer system mounted to the housing and configured to determine that a valve is a passing valve based on acoustic emissions detected by the piezoelectric sensor.

2. The device of claim 1, wherein the instructions comprise: acquiring acoustic emission data from the piezoelectric sensor; and detecting that the valve is a passing valve using a trained machine learning model where an input to the trained machine learning model is based on the acoustic emission data.

3. The device of claim 1, further comprising a strap attached to first and second ends of the housing, the strap configured to maintain contact between the first side of the housing and the pipe.

4. The device of claim 1, further comprising first and second hinged segments rotatably coupled to respective first and second ends of the housing; and magnets coupled to the first and second hinged segments configured to magnetically couple the housing to the pipe.

5. The device of claim 4, wherein the magnets comprise switchable magnets.

6. The device of claim 1, wherein the sensor holder comprises a recess at a first end and a handle at a second end opposite the first end.

7. The device of claim 6, wherein the recess is sized to hold the piezoelectric sensor and a portion of the sensor holder protrudes through an opening of the cover plate.

8. The device of claim 1, further comprising a syringe disposed in the housing, the syringe configured to hold a fluid to be injected between the piezoelectric sensor and the pipe.

9. The device of claim 1, further comprising one or more additional sensors disposed within the housing.

10. The device of claim 9, wherein the one or more additional sensors comprise one or more of an accelerometer, a piezoelectric sensor, a temperature sensor, and a magnetometer.

11. The device of claim 9, wherein determining that the valve is a passing valve is based on the received signals from the piezoelectric sensor and signals from the one or more additional sensors.

12. A system for detecting passing valves, the system comprising:
a sensor device comprising:
a housing comprising a first side configured to contact a wall of a pipe in a pipe system and a second side opposite the first side;
a cover plate coupled to the second side of the housing;
a piezoelectric sensor disposed in the housing and configured to detect acoustic emissions from a valve in the pipe system;
a sensor holder disposed within the housing and configured to maintain a position of the piezoelectric sensor;
a spring positioned around a portion of the sensor holder and configured to bias the sensor holder away from the cover plate and toward the first side of the housing;
a first computer system mounted to the housing comprising at least one processor and a computer-readable medium storing instructions executable by the at least one processor, the computer system configured to transmit acoustic emission data to a computer system located separately from the sensor device; and
a second computer system located separately from the sensor device, the second computer system comprising at least one processor and a computer-readable medium storing instructions executable by the at least one processor, the second computer system configured to determine that the valve is a passing valve based on the acoustic emission data.

13. The system of claim 12, wherein the second computer system comprises instructions to:
receive the acoustic emission data from the first computer system;
extract features from the acoustic emission data; and
determine that the valve is a passing valve using a trained machine learning model that receives the extracted features as inputs.

14. The system of claim 13, wherein the first computer system comprises instructions to:
receive signals from the piezoelectric sensor; extract features from the received signals;
determine that the valve is a passing valve based on a second trained machine learning model that receives the extracted features as inputs; and
transmit output of the second trained machine learning model to the second computer system,
wherein the second computer system further comprises instructions to validate the output of the second trained machine learning model based on output of the first trained machine learning model.

15. The system of claim 12, further comprising:
one or more additional sensors disposed within the housing, the one or more additional sensors comprising one or more of an accelerometer, a piezoelectric sensor, a temperature sensor, and a magnetometer,
wherein determining that the valve is a passing valve is based on the received signals from the piezoelectric sensor and signals from the one or more additional sensors.

16. A method for detecting passing valves, the method comprising:
acquiring, by a computer system, acoustic emission data from a piezoelectric sensor;
extracting, by the computer system, features from the acoustic emission data; and
detecting, by the computer system, that the valve is a passing valve using a trained machine learning model where an input to the trained machine learning model comprises the extracted features.

17. The method of claim 16, coupling a piezoelectric sensor device to a pipe near a valve, the piezoelectric sensor device comprising a piezoelectric sensor and the computer system.

18. The method of claim 16, further comprising injecting a fluid between the piezoelectric sensor and the pipe using a syringe disposed within a housing of the piezoelectric sensor device.

19. The method of claim 16, wherein the computer system is a first computer system, and the method further comprises:
transmitting the acoustic emission data to a second computer system; and
determining, by the second computer system, that the valve is a passing valve using a second trained machine learning model, wherein the second computer system validates the determination of the first computer system.

20. The method of claim 16, wherein extracting the features comprises determining one or more of a root mean square value, a spectral roll off, a spectral bandwidth, a zero-crossing rate, Mel-Frequency Cepstral Coefficients, and a spectrogram.
